(19) United States
(12) Patent Application Publication
(10) Pub. No.: US 2004/0111973 A1
(43) Pub. Date: Jun. 17, 2004

(54) Weatherstrip forming a slideway for a motor vehicle window

(76) Inventors: Emmanuelle Moisy, Montargis (FR); Stephane Drivon, Chalette Sur Loing (FR)

Correspondence Address: CLARK & BRODY, Suite 600, 1750 K Street, NW, Washington, DC, 20006, US

(21) Appl. No.: 10/629,595

(22) Filed: Jul. 30, 2003

(30) Foreign Application Priority Data
Aug. 2, 2002 (FR) 0209871

(51) Int. Cl. E06B 7/16

(52) U.S. Cl. 49/490.1

(57) ABSTRACT

The invention provides a weatherstrip forming a motor vehicle window slideway, the weatherstrip including at least one reinforced clip of channel section with a web and two substantially parallel jaws, and being suitable for fitting onto a flange of the frame of a window opening of the vehicle, wherein the strip is made of a rigid thermoplastic material, and wherein the reinforcing means of the clip are situated either solely in the jaws, or solely in the web of the clip.

The invention relates to a weatherstrip forming a slideway for a motor vehicle window, it being understood that the invention is applicable to any type of motor vehicle whether for use on the road (private cars, utility vehicles, buses, trucks, . . . ) or for use on rail or on water, for example.

### BACKGROUND OF THE INVENTION

In road vehicles, for example, a weatherstrip is mounted on the frame of an opening in a door, the opening being suitable for being open, partially open, or closed by a glass pane sliding under manual and/or automatic control. Such a weatherstrip comprises a wiper which is fixed to the bottom portion of the frame of the window opening and slideways fixed to the top and side portions of said frame.

At present, there are two major families of slideways, namely: non-reinforced flexible slideways which are fitted in channel-section slots formed in the window frame, and reinforced slideways which are fitted on flanges of the window frame, it being understood that. this second family comprises both single-flange slideways and hidden-frame slideways.

A prior art reinforced slideway comprises a channel section clip fitted on the window frame and constituted by a metal strength member embedded in an elastomer material such as rubber, and two branches fitted with sealing lips suitable for coming into sliding contact with opposite sides of the sliding pane.

Such slideways provide satisfactory performance, but they are both heavy and expensive to manufacture.

### OBJECTS AND SUMMARY OF THE INVENTION

An object of the invention is to mitigate the above-mentioned drawbacks and to propose-slideways of design that is optimized both in terms of weight and in terms of cost, while presenting performance that is at least comparable with that of prior art slideways.

To achieve this object, the invention provides a weatherstrip forming a slideway for a motor vehicle window, the strip comprising at least one reinforced clip of channel section with a web and two jaws that are substantially parallel to each other, and suitable for engaging on a flange of the frame of a window opening in the vehicle, wherein the strip is made of a rigid thermoplastic material, and wherein the reinforcing means of the clip are situated either solely in the jaws, or solely in the web of the clip, or else they are situated in one of the jaws and also in the web of the clip.

In general, the weatherstrip constitutes either the top segment of a slideway with reinforcing means situated in one of the jaws of the clip extending substantially parallel to the flange and/or in the web of the clip, or else a vertical segment of a slideway with reinforcing means situated solely. in the web of the clip. extending substantially perpendicularly to the flange.

The reinforcing means may comprise one or more elements, but advantageously they comprise a single reinforcing element in the form of a metal strength member that is flat or optionally corrugated, for example.

The weatherstrip of the invention may also include at least one retaining abutment to oppose the clip, once mounted on the flange, being pulled away, said abutment being advantageously situated towards one end of one of the two jaws of the clip.

In addition, when the clip support flange is constituted by at least two metal sheets, the weatherstrip of the invention may also have at least one lip for controlling the positioning of the clip on the flange as a function of clearances in the metalwork thereof, said clearance-accommodating lip possibly being situated at the root of one of the jaws of the clip. or at the web of the clip.

In general, the weatherstrip of the invention also comprises two branches which are substantially parallel to each other, extending perpendicularly to the flange, the roots of the two branches being connected respectively. towards the two ends of one of the jaws of the clip, and are fitted with sealing lips suitable for coming into sliding contact with the sliding pane, the strip presenting in the vicinity of the root of one of the two branches, a reduction in material forming a hinge to prevent the branch from buckling.

The invention also provides slideways constituted by weatherstrips having all or some of the above-specified characteristics.

### BRIEF DESCRIPTION OF THE DRAWINGS

Other advantages, characteristics, and details of the invention appear from the following additional description made with reference to the accompanying drawings given purely by way of example, and in which:

FIG. 1 is a section view of a weatherstrip forming the top segment of a prior art slideway mentioned in the introduction;

FIG. 2 is a section view of a weatherstrip forming a slideway constituting an embodiment of the invention and capable of forming the top segment of a slideway;

FIG. 3 is a section view of a weatherstrip of the invention forming a vertical segment of a slideway;

FIGS. 4 and 5 are section views of vertical segments of slideways suitable for associating respectively with the top segment of the FIG. 2 slideway; and

FIG. 6 is a section view of a weatherstrip forming a slideway constituting another embodiment of the invention.

### MORE DETAILED DESCRIPTION

The weatherstrip la shown in FIG. 1 represents the prior art mentioned in the introduction and it forms the top segment of a reinforced slideway of the hidden frame type. The weatherstrip includes a clip 3 constituted by reinforcing means 5 in the form of a channel-section metal strength member 5a having a web 7 and two jaws 9 and 11. The strength member 5a is embedded in an elastomer material such as rubber. The clip 3 is fitted onto a flange 13 of a window opening defined by a door covering when the vehicle is a road vehicle, specifically a flange projecting from a roof. The weatherstrip 1a also includes two substantially parallel facing branches 15 and 17 extending perpendicularly to the flange 13, with the roots of the branches being connected towards respective ones of the two ends of the jaw 11 of the clip 3, and are provided with sealing lips 20 suitable for coming into sliding contact with a sliding pane V.

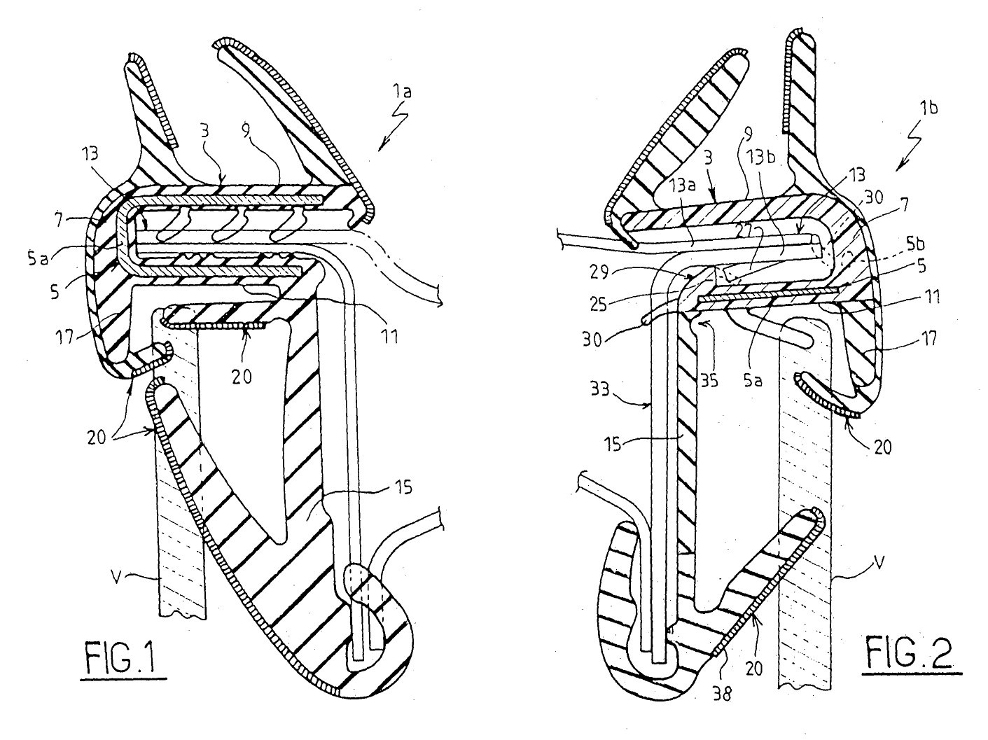

The invention relates to a slideway in general, suitable in particular for forming the top segment of a reinforced slideway of the hidden frame type, for example, as shown in FIG. 2 which shows an embodiment of the invention. In this example, the weatherstrip 1b is of similar overall shape to the strip la shown in FIG. 1, which is why elements that are common to both figures are given the same reference numerals.

In general, at least the clip 3 of the weatherstrip 1b is made of a rigid thermoplastic material such as polyproylene, for example, and the reinforcing means 5 are situated only in one and/or the other jaw 9, 11 of the clip 3. In the example shown, the reinforcing means 5 are situated in the jaw 11 of the clip 3, and they are restricted to a single element in the form of a metal strength member 5a that is substantially flat, extending substantially parallel to the flange 13. Thus, these reinforcing means 5 do not prevent the weatherstrip from taking up the curvature of the flange 13 of the roof.

In order to ensure that the clip 3 holds securely in the weatherstrip assembly direction, so as to oppose extraction or removal of the weatherstrip lb once it has been mounted on the flange 13, a retaining abutment 25 projects into the inside of the clip 3 so as to come substantially into contact with a projection 27 from the flange 13. The retaining abutment 25 may be. formed towards the end of the jaw 9 of the clip 3 in the form of a bulge 29 which defines a shoulder forming the abutment 25. As for the projection 27 from the flange 13, it may be formed, for example, by folding sheet metal, such as a crimping fold, or it may be a separate fitted piece, or it may be in the form of a stamping such as a plunged boss for creating a hard point.

In order to control the positioning of the clip 3 on the flange 13 as a function of sheet metal clearances and to ensure that the assembly is stable, at least one clearance-accommodating lip 30 is provided. In the example shown in FIG. 2, the flange 13 is constituted by two assembled-together pieces of sheet metal 13a and 13b, and the lip 30 is situated at the root of the branch 15. In a variant, the lip 30 may be situated inside the clip 3 either level with the web 7 or else with the projection 27 from the flange 13, as shown in dashed lines.

In general, the two branches 15 and 17 of the weatherstrip 1b are asymmetrical, the branch 15 extending further than the branch 17. The branch 15 is intended to come into contact with a portion 33 of the metalwork. Also, in order to ensure that the branch 15 is pressed securely against the portion of metalwork 33, said branch 15 is extruded so as to be slightly open, and a hinge 35 is provided forming a joint at the root of the branch 15 in order to control the position of the zone in which the branch 15 bends and thus prevent it from buckling. The hinge 35 may be obtained merely by reducing the thickness of the material constituting the branch 15.

In general, the branches 15 and 17 of the weather-strip may also likewise be made of a rigid thermoplastic material similar to that used for making the clip 3, however they also be made of a material having a bending modulus that is much smaller than that of the clip material, such a material possibly being a thermoplastic elastomer (TPE) material, for example. The sealing lips 20 are made of a flexible thermoplastic material, e.g. TPE, and they are given an anti-friction coating 38.

In a variant, reinforcing means may also be provided in the web 7 of the clip 3, these reinforcing means advantageously being restricted to one or more wires 5b (or possibly non-metallic strands), as shown in dashed lines in FIG. 2.

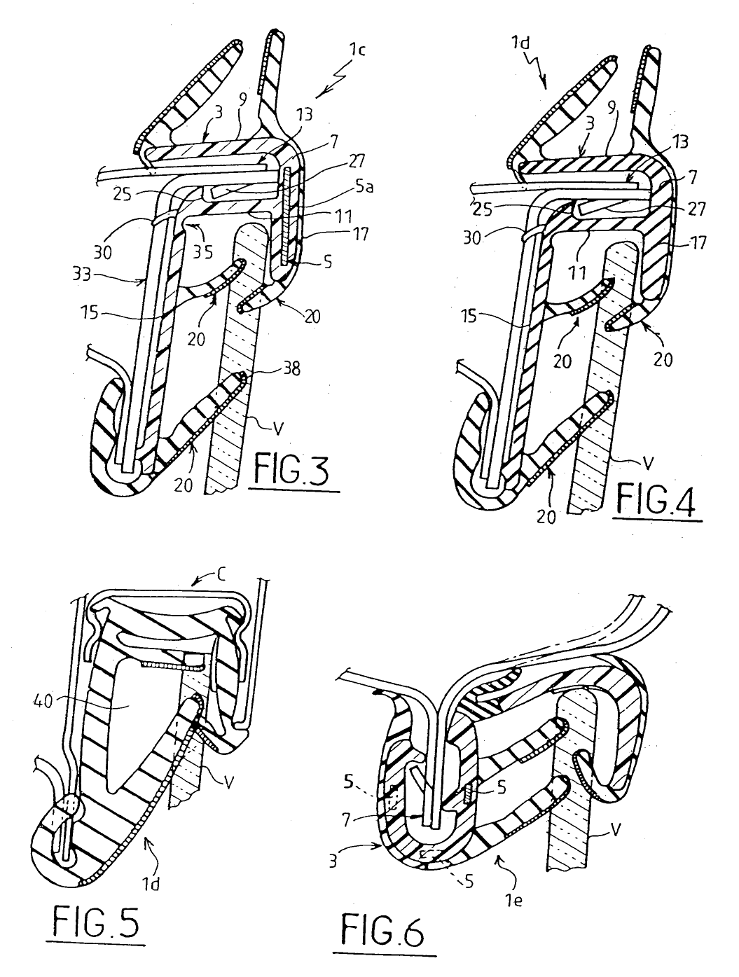

In another embodiment shown in FIG. 3, the weatherstrip 1c of the invention can form a vertical segment of a slideway and differs from the weatherstrip 1b in FIG. 2 essentially by the fact that the reinforcing means 5 are situated in the web 7 of the clip 3 and no longer in one and/or the other of its jaws 9 and 11. In the example shown, the reinforcing means 5 are likewise constituted by a single element in the form of a flat strength member 5a which may extend into the branch 17 situated in line with the web 7 of the clip 3.

The invention also covers a slideway whose top segment is of the type shown in FIG. 2 and whose vertical segments are of the type shown in FIG. 3.

Furthermore, the invention also covers a slideway in which the top segment is of the type shown in FIG. 2, while the vertical segments id are of the type shown in FIGS. 4 and 5. The vertical segment 1d of FIG. 4 reproduces that shown in FIG. 3, but without the presence of any reinforcing means, whereas the vertical segment 1d of FIG. 5 is mounted in a channel-section housing 40 of the window frame C in the door and can be made of a flexible thermoplastic or elastomer material.

Finally, in a last embodiment of the invention as shown in FIG. 6, the weatherstrip le forms a reinforced slideway of the single flange type in which the clip 3 has reinforcing means 5 situated in at least one of its jaws 9 and 11. In a variant, the reinforcing means are situated both in a jaw 9 and in the web 7 of the clip 3.

What is claimed is:

1/ A weatherstrip forming a slideway for a motor vehicle window, the strip comprising at least one reinforced clip of channel section with a web and two jaws that are substantially parallel to each other, and suitable for engaging on a flange of the frame of a window opening in the vehicle, wherein the clip of the strip is made of a rigid thermoplastic material, and wherein the reinforcing means of the clip are situated either solely in the jaws, or solely in the web of the clip, or else they are situated in one of the jaws and also in the web of the clip.

2/ A weatherstrip according to claim 1, constituting the top segment of a slideway, and wherein the reinforcing means are situated in one of the jaws of the clip and extend substantially parallel to the flange, and/or in the web of the clip.

3/ A weatherstrip according to claim 1, constituting a vertical segment of a slideway, and wherein the reinforcing means are situated solely in the web of the clip and extend substantially perpendicularly to the flange.

4/ A weatherstrip according to claim 2, wherein the reinforcing means comprise one or more elements.

5/ A weatherstrip according to claim 2, wherein the reinforcing means comprise a single element in the form of a metal strength member that is substantially plane or corrugated.

6/ A weatherstrip according to claim 1, further comprising at least one retaining abutment for opposing removal of the clip when mounted on the flange.

7/ A weatherstrip according to claim 6, wherein the retaining abutment is situated on one of the two jaws of the clip, extending towards the inside of the clip and being suitable for coming into contact with a projection from the flange.

8/ A weatherstrip according to claim 1, wherein the flange for supporting the clip is constituted by at least one piece of sheet metal, and wherein the strip further comprises at least one lip for controlling the positioning of the clip on the flange as a function of the sheet metal clearances thereof, and wherein the clearance-accommodating lip is positioned at the root of one of the jaws of the clip or at the web of the clip.

9/ A weatherstrip according to claim 1, also comprising two substantially parallel branches extending perpendicularly to the flange, the roots of the two branches being connected towards respective ones of the two ends of one of the jaws of the clip and the branches being fitted with sealing lips suitable for coming into sliding contact with the sliding pane.

10/ A weatherstrip according to claim 9, presenting a reduction of material thickness in the vicinity of the root of one or both branches, said reduction forming a hinge for preventing the branch from buckling.

11/ A weatherstrip according to claim 9, wherein the branches are made of a thermoplastic material having a bending modulus that is much smaller than that of the thermoplastic material used for the clip.

12/ A weatherstrip according to claim 9, wherein both branches are made of a thermoplastic elastomer material.

13/ A weatherstrip according to claim 9, wherein the sealing lip carried by the two branches are made of a flexible thermoplastic material.

14/ A weatherstrip according to claim 1, wherein the clip is made of or based on polypropylene.

15/ A slideway for a motor vehicle window, the slideway comprising a top segment and at least one vertical segment, wherein said top segment has reinforcing means that are are situated in one of the jaws of the clip and extend substantially parallel to the flange, and/or in the web of the clip, and wherein said at least one vertical segment has reinforcing means that are situated solely in the web of the clip and extend substantially perpendicularly to the flange.

16/ A motor vehicle window slideway comprising a top segment and at least one vertical segment, wherein the top segment is constituted by a weatherstrip according to claim 2, and wherein said vertical segment is constituted by a weatherstrip that is not reinforced.

17/ A slideway according to claim 15, wherein said slideway is of the hidden frame type.

18/ A motor vehicle window slideway, forming a single-flange type slideway made from a weatherstrip according to claim 1.
